(19) United States
(12) Patent Application Publication
(10) Pub. No.: US 2026/0242243 A1
(43) Pub. Date: Aug. 20, 2026

(54) PRECURSOR, AND METHOD FOR PRODUCING POSITIVE ELECTRODE ACTIVE MATERIAL FOR LITHIUM SECONDARY BATTERY

(71) Applicant: TANAKA CHEMICAL CORPORATION, Fukui-shi, Fukui (JP)

(72) Inventors: Kenji TAKAMORI, Niihama-shi (JP); Tomoya KURODA, Fukui-shi (JP)

(21) Appl. No.: 18/993,960

(22) PCT Filed: Jul. 14, 2023
(86) PCT No.: PCT/JP2023/026130

§ 371 Date: Jan. 13, 2025

(30) Foreign Application Priority Data
Jul. 15, 2022 (JP) 2022-114296

(51) Int. Cl. C01G 53/84; C01G 53/502; H01M 4/525

(52) U.S. Cl. CPC C01G 53/84; C01G 53/502; H01M 4/525; C01P 2002/54; C01P 2004/61; C01P 2006/11; C01P 2006/12; C01P 2006/21; C01P 2006/40

(57) ABSTRACT

The present invention relates to a precursor of a positive electrode active material for a lithium secondary battery, the precursor including a metal composite compound containing at least one metal element selected from the group consisting of Ni, Co, and Mn, and satisfying all of the following requirements (1) to (3):
(1) An average particle strength is 10 MPa or more and less than 45 MPa;
(2) An average particle diameter D₅₀ is more than 4 μm and equal to or less than 20 μm;
(3) Both a moisture content and a sulfate radical content are 1% by mass or less with respect to the total mass of the precursor.

### TECHNICAL FIELD

The present invention relates to a precursor and a method for producing a positive electrode active material for a lithium secondary battery.

Priority is claimed on Japanese Patent Application No. 2022-114296, filed Jul. 15, 2022, the content of which is incorporated herein by reference.

### BACKGROUND ART

As a method for producing a positive electrode active material for lithium secondary batteries, for example, there is a method of mixing a lithium compound and a metal composite compound containing a metal element other than Li, followed by calcination.

In order to improve the performance of lithium secondary batteries, the metal composite compound described above has been studied. For example, Patent Document 1 discloses a nickel-manganese-cobalt-containing composite hydroxide composed of secondary particles formed by aggregation of a plurality of plate-shaped primary particles and fine primary particles smaller than the plate-shaped primary particles, as a precursor of a positive electrode active material for lithium ion secondary batteries. It has been disclosed that a lithium ion secondary battery produced using a positive electrode active material for lithium ion secondary batteries having the above nickel-manganese-cobalt-containing composite hydroxide as a precursor exhibits high durability and excellent output characteristics.

### CITATION LIST

### Patent Document

Patent Document 1: Japanese Unexamined Patent Application, First Publication No. 2020-177860

### SUMMARY OF INVENTION

### Technical Problem

As the application fields of lithium secondary batteries develop, further improvements are required for the lithium secondary batteries in initial discharge capacity and initial efficiency.

The present invention has been made in view of the above circumstances and aims to provide: a precursor of a positive electrode active material for lithium secondary batteries, from which a lithium secondary battery with high initial discharge capacity and initial efficiency can be obtained; and a method for producing a positive electrode active material for a lithium secondary battery using the precursor.

### Solution to Problem

The present invention includes the following [1] to [6].

[1] A precursor of a positive electrode active material for a lithium secondary battery, the precursor including a metal composite compound containing at least one metal element selected from the group consisting of Ni, Co, and Mn, and satisfying all of the following requirements (1) to (3):
(1) An average particle strength is 10 MPa or more and less than 45 MPa;
(2) An average particle diameter D₅₀ is more than 4 μm and equal to or less than 20 μm;
(3) Both a moisture content and a sulfate radical content are 1% by mass or less with respect to the total mass of the aforementioned precursor.

[2] The precursor according to [1], wherein the aforementioned metal composite compound is represented by the following composition formula (I).

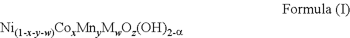

(The aforementioned composition formula (I) satisfies 0≤x≤0.5, 0≤y≤0.5, 0≤w≤0.5, 0≤x+y+w<1, 0≤z≤3, −0.5≤α≤2, and α−z<2, and M is one or more elements selected from the group consisting of Fe, Cu, Ti, Mg, Al, Zn, Sn, Zr, Nb, Ga, W, Mo, B, and Si.)

[3] The precursor according to [1] or [2], which has a standard deviation of particle strength of 1 MPa or more and 9 MPa or less.

[4] The precursor according to any one of [1] to [3], which has a BET specific surface area of 2 m²/g or more and 50 m²/g or less.

[5] The precursor according to any one of [1] to [4], which has a tap density of 1.0 g/cm³ or more and 3.5 g/cm³ or less.

[6] A method for producing a positive electrode active material for a lithium secondary battery, the method including a mixing step for mixing the precursor of any one of [1] to [5] with a lithium compound, and a calcination step for calcining the obtained mixture at a temperature of 500° C. or more and 1,000° C. or less in an oxygen-containing atmosphere.

### Advantageous Effects of Invention

According to the present invention, it is possible to provide: a precursor of a positive electrode active material for lithium secondary batteries, from which a lithium secondary battery with high initial discharge capacity and initial efficiency can be obtained; and a method for producing a positive electrode active material for a lithium secondary battery using the precursor.

### BRIEF DESCRIPTION OF DRAWINGS

FIG. 1 A schematic configuration diagram showing an example of a lithium secondary battery.

FIG. 2 A schematic diagram showing an overall structure of an all-solid-state lithium secondary battery.

### DESCRIPTION OF EMBODIMENTS

The definitions of terms used in the present specification are as follows.

A metal composite compound is hereinafter also referred to as “MCC.”

A positive electrode (cathode) active material for lithium secondary batteries is hereinafter also referred to as “CAM.”

“Ni” indicates elemental Ni, not a simple substance of nickel metal. The same applies to the notations of other elements such as Co and Mn.

The term “primary particle” refers to a particle that does not have a grain boundary when observed at a visual field magnification of 5,000 to 30,000 times using a scanning electron microscope or the like.

The term “secondary particle” refers to a particle formed by aggregation of the primary particles. In other words, secondary particles are aggregates of primary particles.

A “metal element” also includes metalloid elements B and Si.

Regarding numerical ranges, “A or more and B or less” is expressed as “A to B”. For example, when a numerical range is described as “1 to 10 MPa,” it means a range from 1 MPa to 10 MPa, and refers to a numerical range including 1 MPa as the lower limit value and 10 MPa as the upper limit value.

The measurement methods for each parameter of the precursor and MCC in the present specification are as follows.

### (Average Particle Strength)

The average particle strength (unit: MPa) of the precursor can be measured and calculated as follows. First, 20 secondary particles are randomly selected from the precursor. Using a microcompression tester (for example, MCT-510 manufactured by Shimadzu Corporation), the particle diameter and particle strength of each of the selected secondary particles are measured. Here, the particle strength Cs (unit: MPa) can be determined by the following formula (A). In the following formula (A), P denotes the test force (unit: N) and d denotes the particle diameter (unit: mm). P is a pressure value at which the displacement becomes maximum while the test pressure remains almost constant when the test pressure is gradually increased. d is a value obtained by measuring the diameters in the X and Y directions in an image observed by the microcompression tester and calculating the average value thereof.

$$Cs = 2.8 P / π {d}^{2} \qquad ( A )$$

The average value of Cs of the 20 secondary particles obtained is the average particle strength.

Since particle strength is normalized by particle diameter, if the structure of each particle is the same, the particle strength will be the same (average particle strength #5%) even among particles having different particle diameters. On the other hand, if the particle strength differs between particles, it can be said that the structure of each particle is different.

### (Standard Deviation of Particle Strength)

The standard deviation of the particle strength of the precursor can be calculated from the average particle strength and the Cs of the 20 secondary particles obtained as described above in the section entitled (average particle strength).

### (Average Particle Diameter D₅₀)

The average particle diameter D₅₀ (unit: μm) of the precursor can be obtained from the particle size distribution of the precursor measured by a laser diffraction scattering method. More specifically, 0.1 g of a precursor powder is added into 50 mL of a 0.2% by mass aqueous solution of sodium hexametaphosphate to obtain a dispersion liquid in which the powder is dispersed. Next, the particle size distribution of the obtained dispersion liquid is measured using a laser diffraction scattering particle size distribution measuring device (for example, Microtrac MT3300EXII manufactured by MicrotracBEL Corporation) to obtain a volume-based cumulative particle size distribution curve. In the obtained cumulative particle size distribution curve, the particle diameter value at 50 cumulative percent from the fine particle side is the average particle diameter (hereinafter, sometimes referred to as D₅₀).

### (Moisture Content)

The moisture content (unit: % by mass) contained in the precursor can be measured using a moisture meter. As the moisture meter, for example, a coulometric Karl Fischer moisture meter (831 Coulometer, manufactured by Metrohm AG) can be used.

### (Sulfate Radical Content)

The sulfate radical (SO₄²⁻) content (unit: % by mass) contained in the precursor can be measured by inductively coupled plasma emission spectrometry (ICP). For example, after dissolving the precursor in hydrochloric acid, the amount of sulfur atoms can be measured using an inductively coupled plasma optical emission spectrometer (for example, SPS3000, manufactured by SII Nano Technology Inc.). The amount of sulfur atoms obtained can be converted into sulfate radical, thereby obtaining the sulfate radical content.

### (Composition)

The composition of each element in MCC can be measured by inductively coupled plasma emission spectrometry (ICP). For example, after dissolving the precursor in hydrochloric acid, the amount of each element can be measured using an inductively coupled plasma optical emission spectrometer (for example, SPS3000, manufactured by SII Nano Technology Inc.).

### (BET Specific Surface Area)

The BET specific surface area (unit: m²/g) of the precursor can be measured by the BET (Brunauer, Emmett, Teller) method. Nitrogen gas is used as an adsorption gas in measuring the BET specific surface area. For example, after drying 1 g of a precursor powder in a nitrogen atmosphere at 105° C. for 30 minutes, measurement can be conducted using a BET specific surface area meter (for example, Macsorb (registered trademark) manufactured by Mountech Co., Ltd.).

### (Tap Density)

The tap density (unit: g/cm³) of the precursor can be measured in accordance with JIS R 1628-1997.

### (XRD Pattern)

The XRD pattern of the precursor can be obtained by powder X-ray diffraction measurement in which CuKα is used as a radiation source and the measurement range of a diffraction angle 2θ is set in a range of 10 to 90°. For example, an XRD pattern can be obtained for a powder precursor using a powder X-ray diffractometer (for example, Ultima IV, manufactured by Rigaku Corporation). The obtained XRD pattern can be analyzed using analysis software (for example, integrated powder X-ray analysis software PDXL2, manufactured by Rigaku Corporation).

The CAM evaluation method employed in the present specification is as follows.

### (Initial Discharge Capacity and Initial Efficiency)

### <Production of Positive Electrode for Lithium Secondary Battery>

CAM obtained by the production method described below using MCC, a conductive material (acetylene black), and a binder (PVdF) are added and kneaded so as to obtain a composition of CAM: conductive material: binder=92:5:3 (mass ratio) to prepare a paste-like positive electrode mixture. N-methyl-2-pyrrolidone is used as an organic solvent at the time of preparing the positive electrode mixture.

The obtained positive electrode mixture is applied to a 40 μm thick Al foil that serves as a current collector and vacuum dried at 150° C. for 8 hours to obtain a positive electrode for a lithium secondary battery. The electrode area of this positive electrode for a lithium secondary battery is set to 1.65 cm².

### <Production of Lithium Secondary Battery>

The following operations are performed in a glove box with an argon atmosphere.

The above-mentioned positive electrode for a lithium secondary battery is placed on a lower lid of a part for a coin-type battery R2032 (manufactured by Hohsen Corporation) with the aluminum foil surface facing down, and a laminate film separator (thickness: 16 μm) obtained by laminating a heat-resistant porous layer on a porous film made of polyethylene is placed thereon. 300 μl of an electrolytic solution is injected thereinto. As the electrolytic solution, a liquid obtained by dissolving LiPF₆ at a ratio of 1.0 mol/l in a mixed solution obtained by mixing ethylene carbonate, dimethyl carbonate, and ethyl methyl carbonate at a ratio of 30:35:35 (volume ratio) is used.

Next, metallic lithium used as a negative electrode is placed on the upper side of the separator, covered with a top lid through a gasket, and swaged using a swage, thereby producing a lithium secondary battery.

An initial efficiency test is carried out using the above-mentioned lithium secondary battery by the following method to calculate the initial discharge capacity and initial efficiency.

### Initial Efficiency Test

The lithium secondary battery is left to stand at 25° C. for 12 hours, thereby allowing the separator and positive electrode mixture layer to be sufficiently impregnated with the electrolytic solution.

Next, at a test temperature of 25° C., the current value for both charging and discharging is set to 0.2 CA, and constant current/constant voltage charging and constant current discharging are performed, respectively. The maximum charge voltage is set to 4.3 V, and the minimum discharge voltage is set to 2.5 V. The charge time is set to 6 hours, and the discharge time is set to 5 hours. The charge capacity is measured, and the obtained value is taken as the “initial charge capacity” (mAh/g). Furthermore, the discharge capacity is measured, and the obtained value is taken as the “initial discharge capacity” (mAh/g).

The initial efficiency is calculated using the following formula using the initial discharge capacity value and the initial charge capacity value.

$$Initial efficiency ( \% ) = initial discharge capacity ( mAh / g ) / initial charge capacity ( mAh / g ) \times 100 \qquad ( Formula )$$

### <<Metal Composite Compound>>

The precursor is a precursor of CAM. The precursor contains MCC containing at least one metal element selected from the group consisting of Ni, Co, and Mn. The precursor satisfies all of the following requirements (1) to (3).

(1) The average particle strength is 10 MPa or more and less than 45 MPa.

(2) The average particle diameter D₅₀ is more than 4 μm and equal to or less than 20 μm.

(3) Both the moisture content and the sulfate radical content are 1% by mass or less with respect to the total mass of the aforementioned precursor.

The MCC contained in the precursor is an aggregate of a plurality of particles. In other words, the MCC is in a powder form. The MCC may contain only secondary particles, or may be a mixture of primary particles and secondary particles. In addition, the MCC is preferably a metal composite hydroxide, a metal composite oxide, or a mixture thereof.

The content of MCC with respect to the total mass of the precursor is preferably from 97 to 99.9% by mass, more preferably from 97.5 to 99.8% by mass, and still more preferably from 98 to 99.7% by mass. Examples of substances other than MCC, water, and sulfate radicals that may be contained in the precursor include impurities derived from raw materials during production.

### <Requirement (1)>

The average particle strength of the precursor is preferably 15 MPa or more, more preferably 20 MPa or more, and still more preferably 25 MPa or more. The average particle strength is preferably 44 MPa or less, and more preferably 42 MPa or less. The average particle strength is preferably from 15 to 44 MPa, more preferably from 20 to 42 MPa, and still more preferably from 25 to 42 MPa. When the average particle strength is within the above range, the positive electrode for a lithium secondary battery to be obtained is easily formed into a suitable electrode structure, and as a result, the initial discharge capacity and initial efficiency of the lithium secondary battery to be obtained are easily improved.

A precursor that satisfies the requirement (1) is a precursor with low particle strength. It is considered that particle strength is determined by a plurality of factors related to the aggregation state of primary particles, such as the density of primary particles in the secondary particles, the orientation of primary particles, the contact area between primary particles, and the strength of adhesion between primary particles. Further, the above factors are also influenced by the characteristics derived from the primary particles, such as the size and shape of the primary particles. For example, it is considered that even among the precursors in which the density of primary particles in the secondary particles is low, depending on the other factors described above, the average particle strength of the precursors will be 45 MPa or more, which does not satisfy the above requirement (1)

A preferred example of the primary particles that constitute the secondary particles of a precursor that satisfies the requirement (1) and the aggregation state of the primary particles in the secondary particles is described below.

As the primary particles, fully grown primary particles having an anisotropic shape are preferred. The phrase “anisotropic shape” refers to a shape having an aspect ratio of 1.5 or more, which is the ratio of the major axis with respect to the minor axis of the primary particles. The aspect ratio means the ratio of the length (major axis) with respect to the breadth (minor axis) of a rectangle that circumscribes the primary particle and has the smallest area. Examples of anisotropic shapes include rod-like shapes and plate-like shapes. When the primary particles grow sufficiently, the primary particles become relatively large. Large primary particles have a smaller external surface area per unit volume than small primary particles. Therefore, it is considered that the contact area between large primary particles is more likely to be smaller than that of small primary particles when the primary particles aggregate. In addition, it is considered that when the primary particles have an anisotropic shape, the density of the primary particles in the secondary particles is lower than that of primary particles having an isotropic shape. The phrase “isotropic shape” refers to a shape in which the aspect ratio of the primary particles is less than 1.5. Examples of isotropic shapes include regular polyhedron shapes, spherical shapes, and nearly spherical shapes.

When 100 primary particles randomly selected from the secondary particles are observed under a scamming electron microscope, the proportion of primary particles having an aspect ratio of 1.5 or more is preferably from 50 to 100%, more preferably from 70 to 100%, and still more preferably from 85 to 100%.

Of the 100 randomly selected secondary particles, the proportion of secondary particles having a proportion of primary particles with a high aspect ratio as described above is preferably from 50 to 100%, more preferably from 70 to 100%, and still more preferably from 85 to 100%.

The average particle diameter of the primary particles in the secondary particles is preferably from 50 to 2,000 nm, more preferably from 200 to 1,500 nm, and still more preferably from 300 to 1,000 nm. The particle diameter of the primary particles means the average of the minor and major axes of the primary particles when the primary particles are observed under a scanning electron microscope. The average of particle diameters of 20 primary particles randomly selected from one secondary particle can be taken as the average particle diameter of the primary particles.

The aggregation state of primary particles in the secondary particles is preferably such that the density of the primary particles is low, the contact area between the primary particles is small, and the strength of adhesion between the primary particles is small. Such secondary particles tend to have low particle strength and are likely to satisfy the above requirement (1).

In addition, with regard to the aggregation state of primary particles in the secondary particles, the primary particles are preferably oriented in a uniform manner. In such a case, adjacent primary particles slide against each other, and the secondary particles tend to crack. Therefore, such secondary particles tend to have low particle strength and are likely to satisfy the above requirement (1).

The primary particles and the aggregation state of the primary particles in the secondary particles can be confirmed by observation with a scanning electron microscope.

### <Requirement (2)>

D₅₀ of the precursor is preferably 5 μm or more, and more preferably 6 μm or more. The D₅₀ is preferably 17 μm or less, and more preferably 16 μm or less. The D₅₀ is preferably from 5 to 17 μm, and more preferably from 6 to 16 μm. When the D₅₀ is equal to or more than the lower limit value of the above range, the initial discharge capacity is likely to improve. When the D₅₀ is equal to or less than the upper limit value of the above range, the discharge capacity at a high current rate is likely to improve.

### <Requirement (3)>

The moisture content with respect to the total mass of the precursor is preferably 0.95% by mass or less, and more preferably 0.90% by mass or less. The moisture content may be 0.20% by mass or more, 0.30% by mass or more, or 0.40% by mass or more.

The above lower limit values and upper limit values can be arbitrarily combined.

The moisture content is preferably from 0.20 to 1% by mass, more preferably from 0.30 to 0.95% by mass, and still more preferably from 0.40 to 0.90% by mass.

The sulfate radical content with respect to the total mass of the precursor is preferably 0.85% by mass or less, and more preferably 0.75% by mass or less. The sulfate radical content may be 0.10% by mass or more, 0.13% by mass or more, or 0.15% by mass or more.

The above lower limit values and upper limit values can be arbitrarily combined.

The sulfate radical content is preferably from 0.10 to 1% by mass, more preferably from 0.13 to 0.85% by mass, and still more preferably from 0.15 to 0.75% by mass.

The MCC contained in the precursor is a compound having a layered structure. If the precursor contains a large amount of moisture or sulfate radicals, the moisture or sulfate radicals penetrate between the layers of the layered structure of the MCC, and the gap between the layers is easily widened. It is thought that when the gap between the layers is widened, the surfaces of the overlapping layers are easily shifted, and the particle strength is easily reduced. On the other hand, the precursor has a low moisture content and a low sulfate radical content, and is therefore less susceptible to the effect of reduction in particle strength caused by water and sulfate radicals. That is, a precursor having water and sulfate radical contents equal to or less than the above upper limit values is considered to satisfy the above requirement (1) substantially depending only on a plurality of factors related to the aggregation state of the primary particles described above. Therefore, when the water and sulfate radical contents are equal to or less than the above upper limit values and the requirement (1) is satisfied, the initial discharge capacity and the initial efficiency are likely to be improved.

In addition to the above requirements (1) to (3), the precursor preferably satisfies the following physical properties.

The standard deviation of particle strength of the precursor is preferably 1 MPa or more, more preferably 3 MPa or more, and still more preferably 5 MPa or more. The standard deviation of particle strength is preferably 9 MPa or less, more preferably 8.95 MPa or less, and still more preferably 8.90 MPa or less. The standard deviation of particle strength is preferably from 1 to 9 MPa, more preferably from 3 to 8.95 MPa, and still more preferably from 5 to 8.90 MPa. When the standard deviation of particle strength is equal to or more than the lower limit value of the above range, particle cracking due to contact between particles is unlikely to occur, and handling properties are likely to be improved. When the standard deviation of particle strength is equal to or less than the upper limit value of the above range, the uniformity of the precursor is high, and the cycle characteristics, initial discharge capacity, and initial efficiency of a battery using the obtained CAM are likely to be improved.

The BET specific surface area of the precursor is preferably 2 m²/g or more, more preferably 5 m²/g or more, still more preferably 10 m²/g or more, and particularly preferably 20 m²/g or more. The BET specific surface area is preferably 50 m²/g or less, more preferably 48 m²/g or less, and still more preferably 46 m²/g or less. The BET specific surface area is preferably from 2 to 50 m²/g, more preferably from 5 to 48 m²/g, still more preferably from 10 to 46 m²/g, and particularly preferably from 20 to 46 m²/g. When the BET specific surface area is within the above range, it is easy to adjust the paste viscosity when producing an electrode using the obtained CAM. Further, when the BET specific surface area is within the above range, the initial discharge capacity and initial efficiency are likely to be improved.

The tap density of the precursor is preferably 1.0 g/cm³ or more, more preferably 1.01 g/cm³ or more, and still more preferably 1.02 g/cm³ or more. The tap density is preferably 3.5 g/cm³ or less, more preferably 3.3 g/cm³ or less, and still more preferably 3.1 g/cm³ or less. The tap density is preferably from 1.0 to 3.5 g/cm³, more preferably from 1.01 to 3.3 g/cm³, and still more preferably from 1.02 to 3.1 g/cm³. When the tap density is equal to or more than the lower limit value of the above range, the production efficiency during the production of CAM is likely to be improved. When the tap density is equal to or less than the upper limit value of the above range, the heat distribution during the production of CAM becomes uniform, and the cycle characteristics, initial discharge capacity, and initial charge/discharge efficiency of a battery using the obtained CAM are likely to be improved.

From the viewpoint of facilitating the reaction during the production of CAM, the crystal structure of MCC is preferably a layered structure, more preferably belonging to any one of hexagonal, orthorhombic and monoclinic crystal systems, and still more preferably belonging to hexagonal crystal systems.

The MCC contained in the precursor preferably has high crystallinity and exhibits anisotropy. In the XRD pattern of the precursor, the sum (α1+β1) of the crystallite size α1 (nm) at a peak Al present in the range of diffraction angle 2θ=19.2±1° and the crystallite size β1 (nm) at a peak B1 present in the range of 2θ=38.5±1° is preferably from 10 to 80 nm, and the ratio thereof (α1/β1) is preferably 0.85 or more. The ratio (α1/β1) is more preferably from 0.85 to 1.60, and still more preferably from 0.85 to 1.57. When the sum (α1+β1) or the ratio (α1/β1) is within the above range, it means that the MCC has high crystallinity and exhibits anisotropy, and the initial discharge capacity and initial efficiency can be improved.

### (Method of Obtaining α1 and β1)

The above α1 and β1 can be obtained as follows.

First, for the precursor, peaks corresponding to the peak A1 and the peak B1 are determined by the method described above in the section entitled (XRD pattern). Furthermore, the half width of each determined peak is calculated, and the crystallite size can be calculated using the Scherrer formula: D=Kλ/B cos θ (D: crystallite size, K: Scherrer constant, B: peak half width). The calculation of crystallite size using the above formula is a method that has been conventionally used (see, for example, “X-ray structural analysis—determination of the arrangement of atoms—”, 3rd edition issued on Apr. 30, 2002, written by Yoshio Waseda and Eiichiro Matsubara).

### <Composition>

The MCC contained in the precursor contains at least one metal element selected from the group consisting of Ni, Co, and Mn. The MCC preferably contains Ni, and more preferably contains Ni and at least one metal element selected from the group consisting of Co and Mn. The MCC does not substantially contain Li. The above expression “does not substantially contain Li” means that the ratio of the number of moles of Li with respect to the total number of moles of Ni, Co, and Mn in the MCC is 0.1 or less.

### <<Composition Formula>>

The MCC is preferably represented by the following composition formula (I).

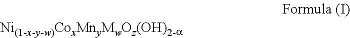

The above composition formula (I) satisfies 0≤x≤0.5, 0≤y≤0.5, 0≤w≤0.5, 0≤x+y+w<1, 0≤2≤3, −0.5≤α≤2, and α−z<2, and M is one or more elements selected from the group consisting of Fe, Cu, Ti, Mg, Al, Zn, Sn, Zr, Nb, Ga, W, Mo, B, and Si.

The MCC is preferably a hydroxide represented by the following composition formula (I)-1.

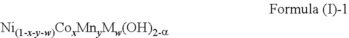

The above composition formula (I)-1 satisfies 0≤x≤0.5, 0≤y≤0.5, 0≤w≤0.5, 0≤x+y+w<1, and −0.5≤α<2, and M is one or more elements selected from the group consisting of Fe, Cu, Ti, Mg, Al, Zn, Sn, Zr, Nb, Ga, W, Mo, B, and Si.

When w is greater than 0, from the viewpoint that the cycle characteristics, initial discharge capacity, and initial efficiency of a battery using the obtained CAM are likely to be improved, M is preferably one or more elements selected from the group consisting of Ti, Mg, Al, Zr, Nb, W, Mo, B, and Si, and more preferably one or more elements selected from the group consisting of Al, Zr, Nb, W, and B.

x is preferably 0.01 or more, more preferably 0.02 or more, and still more preferably 0.03 or more.

x is preferably 0.44 or less, more preferably 0.42 or less, still more preferably 0.40 or less, and particularly preferably less than 0.10. In one embodiment of the present invention, x is preferably 0.

When M is one or more elements selected from the group consisting of Al, Zr, Nb, W, and B, and w exceeds 0, the cycle characteristics, initial discharge capacity, and initial efficiency of a battery using the obtained CAM are likely to be improved even when x is 0 or y is 0.

The above upper limit values and lower limit values of x can be arbitrarily combined.

The above composition formula (I) or the above composition formula (I)-1 preferably satisfies 0.01≤x≤0.44, more preferably satisfies 0.02≤x≤0.42, still more preferably satisfies 0.03≤x≤0.40, and particularly preferably satisfies 0.03≤x<0.10.

y is preferably 0.01 or more, more preferably 0.02 or more, and still more preferably 0.03 or more.

y is preferably 0.44 or less, more preferably 0.42 or less, still more preferably 0.40 or less, and particularly preferably less than 0.10. In one embodiment of the present invention, y is preferably 0.

The above upper limit values and lower limit values of y can be arbitrarily combined.

The above composition formula (I) or the above composition formula (I)-1 preferably satisfies 0.01≤y≤0.44, more preferably satisfies 0.02≤y≤0.42, still more preferably satisfies 0.03≤y≤0.40, and particularly preferably satisfies 0.03≤y<0.10.

w is preferably 0.01 or more, more preferably 0.02 or more, and still more preferably 0.03 or more.

w is preferably 0.44 or less, more preferably 0.42 or less, still more preferably 0.40 or less, and particularly preferably 0.20 or less. In one embodiment of the present invention, w is preferably 0.

The above upper limit values and lower limit values of w can be arbitrarily combined.

When w exceeds 0, the above composition formula (I) or the above composition formula (I)-1 preferably satisfies 0.01≤w≤0.44, more preferably satisfies 0.02≤w≤0.42, still more preferably satisfies 0.03≤w≤0.40, and particularly preferably satisfies 0.03≤w≤0.20.

x+y+w is preferably 0.03 or more, more preferably 0.04 or more, and still more preferably 0.05 or more.

x+y+w is preferably 0.60 or less, more preferably 0.40 or less, and still more preferably 0.20 or less.

The above upper limit values and lower limit values of x+y+w can be arbitrarily combined.

The above composition formula (I) or the above composition formula (I)-1 preferably satisfies 0.03≤x+y+w≤0.60, more preferably satisfies 0.04≤x+y+w≤0.40, and still more preferably satisfies 0.05<x+y+w<0.20.

z is preferably 0.02 or more, more preferably 0.03 or more, and still more preferably 0.05 or more.

z is preferably 2.8 or less, more preferably 2.6 or less, and still more preferably 2.4 or less. In one embodiment of the present invention, z is preferably 0.

The above upper limit values and lower limit values of z can be arbitrarily combined.

The above composition formula (I) preferably satisfies 0≤z≤2.8, more preferably satisfies 0.02≤z≤2.8, still more preferably satisfies 0.03≤z≤2.6, and particularly preferably satisfies 0.05≤z≤2.4.

In one aspect of the present invention, the composition formula (I) preferably satisfies 0≤z≤0.5, more preferably satisfies 0.02≤z≤0.3, still more preferably satisfies 0.03≤z≤0.2, and particularly preferably satisfies 0.05≤z≤0.15.

α is preferably −0.45 or more, more preferably −0.40 or more, and still more preferably −0.35 or more.

α is preferably 1.8 or less, more preferably 1.6 or less, and still more preferably 1.4 or less. The above upper limit values and lower limit values of α can be arbitrarily combined.

The above composition formula (I) or the above composition formula (I)-1 preferably satisfies −0.45≤α≤1.8, more preferably satisfies −0.40≤α≤1.6, and still more preferably satisfies −0.35≤α≤1.4.

The above composition formula (I) or the above composition formula (I)-1 preferably satisfies 0.01≤x≤0.44, 0.01≤y≤0.44, 0≤w≤0.44, 0.03≤x+y+w≤0.60, and −0.45≤α≤1.8, and the above composition formula (I) preferably satisfies 0≤z≤2.8.

### <Method for Producing Precursor>

The method for producing a precursor includes reacting a solution of a metal salt containing at least one element selected from the group consisting of Ni, Co, and Mn, a complexing agent, and an alkaline solution. In this case, the MCC contained in the obtained precursor becomes a metal composite hydroxide. The metal composite hydroxide can be produced by a batch-type coprecipitation method or a continuous-type coprecipitation method. When producing a metal composite oxide as the MCC contained in the precursor, the metal composite hydroxide can be oxidized.

Hereinafter, a method for producing a precursor containing MCC containing Ni, Co, and Mn will be described as an example. More specifically, a nickel salt solution, a cobalt salt solution, a manganese salt solution, and a complexing agent are reacted by the continuous coprecipitation method described in Japanese Unexamined Patent Application, First Publication No. 2002-201028 to produce a metal composite hydroxide represented by Ni_{(1-x′-y′)}CoₓMn_{y}(OH)₂. For example, when producing a precursor containing MCC represented by the above composition formula (I) and the above composition formula (I)-1, x′ and y′ correspond to x and y in the above composition formula (I) and the above composition formula (I)-1, respectively.

By adding a complexing agent, a precursor that satisfies the requirements (1) to (3) can be obtained.

As a nickel salt serving as a solute of the nickel salt solution, for example, at least one of nickel sulfate, nickel nitrate, nickel chloride, and nickel acetate can be used.

As a cobalt salt serving as a solute of the cobalt salt solution, for example, at least one of cobalt sulfate, cobalt nitrate, cobalt chloride, and cobalt acetate can be used.

As a manganese salt serving as a solute of the manganese salt solution, for example, at least one of manganese sulfate, manganese nitrate, manganese chloride, and manganese acetate can be used.

It should be noted that even when producing a precursor containing MCC containing a metal element other than Ni, Co, and Mn, a sulfate, nitrate, chloride, or acetate of this metal element can be used as the solute.

The metal salt is used in a ratio corresponding to the composition ratio of the above Ni_{(1-x′-y′)}CoₓMn_{y}(OH)₂. That is, the amount of each metal salt is specified so that the molar ratio of Ni, Co, and Mn in a mixed solution containing the above metal salts corresponds to (1-x′-y′): x′:y′ in the above composition formula. Further, water is used as a solvent.

The complexing agent is capable of forming a complex with nickel ions, cobalt ions, and manganese ions in an aqueous solution, examples thereof include ammonium ion donors such as ammonium hydroxide, ammonium sulfate, ammonium chloride, ammonium carbonate, and ammonium fluoride, hydrazine, ethylenediaminetetraacetic acid, nitrilotriacetic acid, uracildiacetic acid, and glycine, and ammonium ion donors are preferred.

The amount of the complexing agent contained in a mixed solution containing the nickel salt solution, cobalt salt solution, manganese salt solution, and complexing agent is preferably such that, for example, the molar ratio with respect to the total number of moles of the metal salts (nickel salt, cobalt salt, and manganese salt) is greater than 0 and equal to or less than 2.0.

When an ammonium ion donor is used as the complexing agent, the ammonia concentration with respect to the total volume of the solution in the reaction tank is preferably from 1 to 15 g/L, more preferably from 2 to 12 g/L, and still more preferably from 3 to 10 g/L. When the ammonia concentration is equal to or higher than the lower limit value of the above range, the complexing agent is likely to cause particle growth of MCC, and the precursor is likely to have a D₅₀ of more than 4 μm. In addition, a precursor that satisfies the above requirement (1) and preferably has a tap density or BET specific surface area within the above range is easily obtained. When the ammonia concentration is equal to or lower than the upper limit value of the above range, excessive growth of MCC particles is suppressed, and the precursor is likely to have a D₅₀ of 20 μm or less. The above-mentioned tendency is easily confirmed in precursors produced under equivalent conditions other than the ammonia concentration.

In the coprecipitation method, in order to adjust the pH value of the mixed solution containing the nickel salt solution, cobalt salt solution, manganese salt solution, and complexing agent, an alkaline solution is added to the mixed solution before the pH of the mixed solution changes from alkaline to neutral. Examples of the alkaline solution include an aqueous solution of an alkali metal hydroxide. Further, examples of the alkali metal hydroxide include sodium hydroxide and potassium hydroxide.

It should be noted that the pH value in the present specification is defined as a value measured when the temperature of the mixed solution is 40° C. The pH of the mixed solution is measured when the temperature of the mixed solution sampled from the reaction tank reaches 40° C. When the sampled mixed solution is not at 40° C., the mixed solution is heated or cooled to 40° C. and the pH is measured.

When the above nickel salt solution, cobalt salt solution, manganese salt solution, and complexing agent are continuously supplied to the reaction tank, Ni, Co. and Mn react to produce Ni_{(1-x′-y′)}Co_{x′}Mn_{y′}(OH)₂.

The reaction temperature is preferably from 40 to 80° C., more preferably from 55 to 77° C., and still more preferably from 60 to 75° C. In particular, when producing MCC in which x+y+z in the above composition formula (I) is 0.20 or less, the reaction temperature is preferably 55 to 77° C. When the reaction temperature is within the above range, a precursor that satisfies the above requirement (1) is easily obtained. In particular, when the reaction temperature is equal to or higher than the lower limit value of the above range, the average particle strength of the obtained precursor is likely to be less than 45 MPa. When the reaction temperature is within the above range, a precursor in which at least one of the tap density and BET specific surface area is within the above range is easily obtained.

The pH value in the reaction tank is preferably from 9 to 12.8, and more preferably from 10 to 12.5. When the pH value is within the above range, a precursor that satisfies the above requirement (1) and preferably has at least one of the tap density and BET specific surface area within the above range is easily obtained.

The reaction precipitate formed in the reaction tank is neutralized while being stirred. The time for neutralizing the reaction precipitate is, for example, from 1 to 20 hours.

The stirring is preferably performed while rotating a stirrer having a stirring blade. By performing the stirring, the material in the reaction tank is appropriately stirred and the mixed state in the reaction tank can be appropriately maintained, so that the reaction conditions adjusted as described above are easily reflected in the physical properties of the precursor.

The ratio of the volume of the solution in the reaction tank with respect to the stirring rotation speed (that is, (volume of solution in reaction tank)/(stirring rotation speed)) is preferably 0.1 L/rpm or more, more preferably 0.2 L/rpm or more, and still more preferably 0.3 L/rpm or more. The above ratio may be 2.0 L/rpm or less, 1.5 L/rpm or less, or 1.0 L/rpm or less.

The above lower limit values and upper limit values can be arbitrarily combined.

The above ratio is preferably from 0.1 to 2.0 L/rpm, more preferably from 0.2 to 1.5 L/rpm, and still more preferably from 0.3 to 1.0 L/rpm.

When the above ratio is equal to or more than the lower limit value of the above range, a precursor that satisfies the above requirements (1) and (3) and preferably has at least one of the standard deviation of particle strength and the BET specific surface area within the above range is easily obtained. In particular, when the above ratio is equal to or more than the lower limit value of the above range, the average particle strength of the obtained precursor is likely to be less than 45 MPa. Here, the volume of the solution in the reaction tank refers to the total volume of the mixed solution containing the metal salt solution, complexing agent, and alkaline solution present in the reaction tank at the time when the desired pH and ammonia concentration are adjusted.

As the reaction tank used in a continuous-type coprecipitation method, a type of reaction tank that overflows can be used in order to separate the formed reaction precipitate.

When producing a metal composite hydroxide by a batch-type coprecipitation method, examples of the reaction tank include a reaction tank without an overflow pipe, and a device equipped with a concentration tank connected to an overflow pipe and having a mechanism by which the overflowed reaction precipitate is concentrated in the concentration tank and circulated once again to the reaction tank.

Various gases, for example, inert gases such as nitrogen, argon, or carbon dioxide, oxidizing gases such as air or oxygen, or a mixture of these gases, may be supplied into the reaction tank. As a substance for promoting the oxidation stale other than gases, peroxides such as hydrogen peroxide, peroxide salts such as permanganates, perchlorates, hypochlorites, nitric acid, halogens, ozone, and the like can be used. As a substance for promoting the reduction state, organic acids such as oxalic acid and formic acid, sulfites, hydrazine and the like can be used. The oxidation state in the reaction tank is likely to affect the moisture and sulfate radical content of the obtained precursor. When the oxidation state is promoted, since it may be difficult to remove moisture and sulfate radicals in the subsequent washing step, it is preferable to adjust the conditions appropriately.

In the present embodiment, it is preferable to supply an inert gas into the reaction tank. By supplying an inert gas into the reaction tank, it becomes easier to obtain a precursor that satisfies the above requirement (3).

The use of a complexing agent, the temperature and pH in the reaction tank described above, the ammonia concentration with respect to the total volume of the solution in the reaction tank, and the ratio of (volume of solution in reaction tank)/(stirring rotation speed) greatly affect the particle strength and D₅₀ of the obtained precursor. It is preferable to appropriately adjust various conditions in order to obtain a precursor that satisfies the above requirements (1) to (3).

In the present embodiment, it is preferable to: add a complexing agent, set the reaction temperature to 40 to 80° C., set the ammonia concentration with respect to the total volume of the solution in the reaction tank to 1 to 15 g/L, and set the ratio of (volume of solution in reaction tank)/(stirring rotation speed) to 0.1 to 2.0 L/rpm; it is more preferable to: add a complexing agent, set the reaction temperature to 55 to 77° C., set the ammonia concentration with respect to the total volume of the solution in the reaction tank to 2 to 12 g/L, and set the ratio of (volume of solution in reaction tank)/(stirring rotation speed) to 0.2 to 1.5 L/rpm; and it is still more preferable to: add a complexing agent, set the reaction temperature to 60 to 75° C., set the ammonia concentration with respect to the total volume of the solution in the reaction tank to 3 to g/L, and set the ratio of (volume of solution in reaction tank)/(stirring rotation speed) to 0.3 to 1.0 L/rpm.

By setting such reaction conditions, it becomes easier to obtain a precursor that satisfies the above requirements (1) to (3).

After the above reaction, the neutralized reaction precipitate is washed with water and then isolated. For the isolation, for example, a method of dehydrating a slurry containing the reaction precipitate (that is, a coprecipitated slurry) by centrifugation, suction filtration or the like is used.

The isolated reaction precipitate is washed, dehydrated, dried, and sieved as necessary to obtain a metal composite hydroxide containing Ni, Co, and Mn.

The reaction precipitate is preferably washed with water, weak acid water, or an alkaline cleaning solution. In the present embodiment, washing with an alkaline cleaning solution is preferred, and washing with an aqueous sodium hydroxide solution or an aqueous potassium hydroxide solution is more preferred.

It is preferable to wash with water, weak acid water, or an alkaline cleaning solution in a mass of 10 times or more the mass of the reaction precipitate. In addition, the temperature of the water, weak acid water, or alkaline cleaning solution used is preferably 30° C. or higher. Furthermore, if washing is performed batchwise, it is preferable to perform washing two or more times.

It should be noted that after washing with a solution other than water, it is preferable to further wash with water so that compounds derived from the solution do not remain in the reaction precipitate. By performing washing under the above conditions, the sulfate radical content of the precursor tends to be 1% by mass or less.

The drying temperature is preferably from 80 to 250° C., and more preferably from 90 to 230° C. The drying time is preferably from 0.5 to 24 hours, and more preferably from 1 to 10 hours. The drying pressure may be normal pressure or reduced pressure. By performing drying under such conditions, the moisture content of the precursor tends to be 1% by mass or less.

When producing a metal composite oxide as MCC, a metal composite hydroxide may be heated to produce a metal composite oxide. If necessary, a plurality of heating steps may be performed. In the present specification, the heating temperature means the set temperature of a heating device. In the case of including a plurality of heating steps, it means the temperature when heating is performed at the maximum holding temperature in each heating step.

The heating temperature is preferably from 400 to 700° C., and more preferably from 450 to 680° C. When the heating temperature is from 400 to 700° C., the metal composite hydroxide is sufficiently oxidized, and a metal composite oxide having a BET specific surface area within an appropriate range is obtained.

The time for holding the above heating temperature may be from 0.1 to 20 hours, and is preferably from 0.5 to 10 hours. The rate of temperature increase to the above heating temperature is, for example, from 50 to 400° C./hour. Further, as the heating atmosphere, air, oxygen, nitrogen, argon, or a mixed gas thereof can be used.

The inside of the heating device may be under an appropriate oxygen-containing atmosphere. The oxygen-containing atmosphere may be a mixed gas atmosphere of an inert gas and an oxidizing gas, or may be a state in which an oxidizing agent is present under an inert gas atmosphere. By having an appropriate oxygen-containing atmosphere inside the heating device, a transition metal contained in the metal composite hydroxide is appropriately oxidized, making it easier to control the form of the metal composite oxide.

As the oxygen or oxidizing agent in the oxygen-containing atmosphere, a sufficient number of oxygen atoms need to be present in order to oxidize the transition metal.

When the oxygen-containing atmosphere is a mixed gas atmosphere of an inert gas and an oxidizing gas, the atmosphere in the heating device can be controlled by a method of allowing the oxidizing gas to pass through the heating device, bubbling the oxidizing gas into the mixed solution, or the like.

As the oxidizing agent, peroxides such as hydrogen peroxide, peroxide salts such as permanganates, perchlorates, hypochlorites, nitric acid, halogens, ozone, and the like can be used.

By heating the metal composite hydroxide obtained by the above-mentioned production method under the above-mentioned conditions, a metal composite oxide that satisfies the requirements (1) to (3) can be obtained.

By the steps described above, a precursor can be produced.

### <<Method for Producing Positive Electrode Active Material for Lithium Secondary Battery>>

The method for producing CAM includes a mixing step for mixing a precursor with a lithium compound, and a calcination step for calcining the obtained mixture at a temperature of 500 to 1,000° C. in an oxygen-containing atmosphere. CAM can be produced by the above method.

The above-mentioned precursor is used in the method for producing CAM.

### [Mixing Step]

The precursor and the lithium compound are mixed.

As the above lithium compound, at least any one of lithium carbonate, lithium nitrate, lithium acetate, lithium hydroxide, lithium hydroxide hydrate, lithium oxide, lithium chloride, and lithium fluoride can be used. Among these, any one of lithium hydroxide, lithium hydroxide hydrate, and lithium carbonate, or a mixture thereof is preferred. Further, when the raw material (reagent or the like) containing lithium hydroxide contains lithium carbonate, the content of lithium carbonate in the lithium hydroxide is preferably 5% by mass or less.

The lithium compound and the precursor are mixed in consideration of the composition ratio of the final target product, thereby obtaining a mixture of the lithium compound and the precursor. The amount of Li with respect to the total amount (taken as 1) of metal elements contained in the precursor (molar ratio) is preferably from 0.98 to 1.20, more preferably from 1.01 to 1.10, and still more preferably from 1.03 to 1.10.

### [Calcination Step]

The obtained mixture is calcined at a calcination temperature of 500 to 1,000° C. in an oxygen-containing atmosphere. By calcining the mixture, CAM crystals grow.

The calcination temperature in the present specification refers to the temperature of the atmosphere in the calcination device, and means the maximum temperature of the holding temperature (maximum holding temperature).

When the calcination step includes a plurality of calcination stages, the calcination temperature means the temperature when calcining at the maximum holding temperature in each calcination stage.

The calcination temperature is preferably from 600 to 900° C., more preferably from 650 to 850PC, and still more preferably from 680 to 820° C. When the calcination temperature is equal to or higher than the lower limit value of the above range, a CAM having a strong crystal structure can be obtained. Further, when the calcination temperature is equal to or lower than the upper limit value of the above range, the volatilization of lithium ions on the particle surface of the CAM can be reduced.

The retention time in the calcination step is preferably from 1 to 50 hours, and more preferably from 2 to 20 hours. When the retention time in the calcination step is equal to or less than the upper limit value of the above range, the volatilization of lithium ions is suppressed, and the deterioration in battery performance is suppressed. When the retention time in the calcination step is equal to or more than the lower limit value of the above range, the development of crystals is promoted, and the deterioration in battery performance is suppressed.

In the calcination step, the rate of temperature increase until reaching the maximum holding temperature is preferably 80° C./hour or more, more preferably 100° C./hour or more, and still more preferably 150° C./hour or more. The rate of temperature increase until reaching the maximum holding temperature is calculated from the time ranging from the start of temperature increase up to a point reaching the holding temperature in the calcination device.

The calcination step preferably includes a plurality of calcination stages with different calcination temperatures. For example, it is preferable to include a first calcination stage and a second calcination stage in which calcination is performed at a higher temperature than that in the first calcination stage. Calcination stages with different calcination temperatures and calcination times may be further included.

Depending on the desired composition, as the calcination atmosphere, air, oxygen, nitrogen, argon, a mixed gas thereof or the like is used. The calcination atmosphere is preferably an oxygen-containing atmosphere.

The mixture of the precursor and the lithium compound may be calcined in the presence of an inert melting agent. The inert melting agent is added to such an extent that the initial capacity of the battery using the CAM is not impaired, and may remain in the calcination product. As the inert melting agent, for example, the inert melting agent described in WO 2019/177032A1 can be used.

The calcination device used at the time of calcination is not particularly limited, and may be, for example, a continuous calcination furnace or a fluidized calcination furnace. Examples of the continuous calcination furnace include a tunnel furnace and a roller hearth kiln. As a fluidized calcination furnace, a rotary kiln may be used. CAM is obtained by calcining the mixture of the precursor and the lithium compound as described above. It should be noted that after calcination, washing with water and drying may be performed as appropriate.

### <Lithium Secondary Battery>

A suitable positive electrode for a lithium secondary battery when the CAM produced by the production method of the present embodiment is used will be described. Hereinafter, the positive electrode for a lithium secondary battery may be referred to as the positive electrode.

Furthermore, a lithium secondary battery as a suitable use of a positive electrode will be described.

An example of a suitable lithium secondary battery when using the CAM produced by the production method of the present embodiment includes a positive electrode and a negative electrode, a separator sandwiched between the positive electrode and the negative electrode, and an electrolytic solution disposed between the positive electrode and the negative electrode.

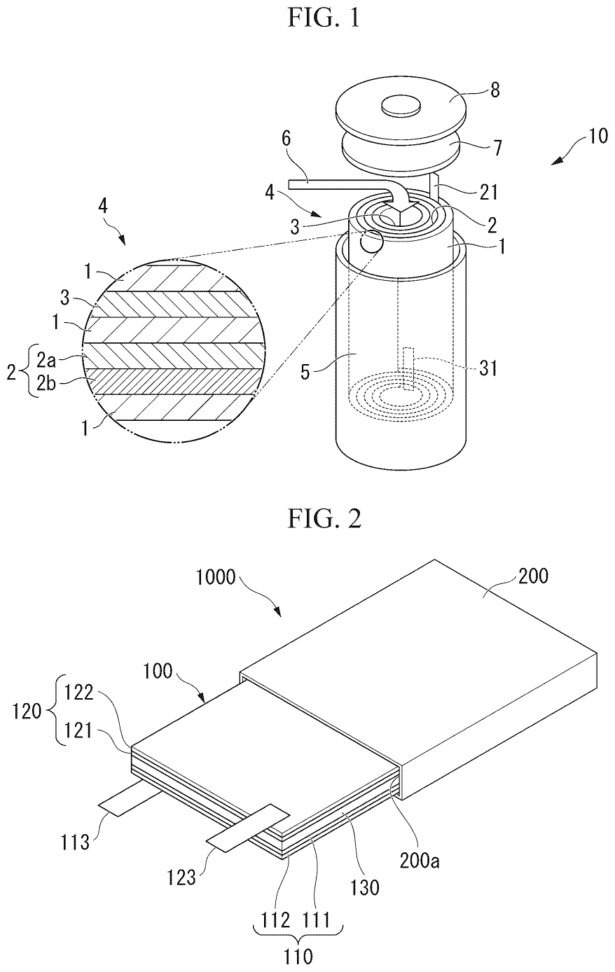

FIG. 1 is a schematic diagram showing an example of a lithium secondary battery. For example, a cylindrical lithium secondary battery 10 is produced as follows.

First, as shown in the partially enlarged view of FIG. 1, a pair of separators 1 having a strip shape, a strip-shaped positive electrode 2 having a positive electrode lead 21 at one end, and a strip-shaped negative electrode 3 having a negative electrode lead 31 at one end are laminated in an order of the separator 1, the positive electrode 2, the separator 1, and the negative electrode 3, and are wound to form an electrode group 4.

The positive electrode 2 includes, as an example, a positive electrode active material layer 2a containing CAM, and a positive electrode current collector 2b in which the positive electrode active material layer 2a is formed on one side. This type of positive electrode 2 can be produced by first preparing a positive electrode mixture containing CAM, a conductive material, and a binder, and then supporting the positive electrode mixture on one side of the positive electrode current collector 2b to form the positive electrode active material layer 2a.

Examples of the negative electrode 3 include an electrode in which a negative electrode mixture containing a negative electrode active material (not shown) is supported on a negative electrode current collector, and an electrode composed solely of a negative electrode active material, and can be produced in the same manner as that applied for the positive electrode 2.

Subsequently, after accommodating the electrode group 4 and an insulator (not shown) in a battery can 5, the bottom of the can is sealed, and the electrode group 4 is impregnated with an electrolytic solution 6 such that an electrolyte is disposed between the positive electrode 2 and the negative electrode 3. Furthermore, by sealing an upper portion of the battery can 5 with a top insulator 7 and a sealing body 8, the lithium secondary battery 10 can be produced.

Examples of the shape of the electrode group 4 include a columnar shape so that the cross-sectional shape when the electrode group 4 is cut in the direction perpendicular to the winding axis is a circle, an ellipse, a rectangle, or a rectangle with rounded corners.

Further, as the shape of the lithium secondary battery having such an electrode group 4, the shape prescribed by IEC60086, which is a standard for batteries prescribed by the International Electrotechnical Commission (IEC), or by JIS C 8500 can be adopted. Examples thereof include a cylindrical shape, a square shape and the like.

Furthermore, the lithium secondary battery is not limited to the wound type configuration as described above, and may have a laminated type configuration in which a laminated structure of a positive electrode, a separator, a negative electrode and a separator is repeatedly overlaid. Examples of the laminated type lithium secondary battery include the so-called coin type batteries, button type batteries, and paper type (or sheet type) batteries.

For the positive electrode, separator, negative electrode, and electrolytic solution that constitute the lithium secondary battery, for example, the configuration, materials, and production method described in sections [0113] to [0140] in WO 2022/113904A1 can be used.

<all-Solid-State Lithium Secondary Battery>

The CAM produced by the production method of the present embodiment can be used for an all-solid-state lithium secondary battery.

FIG. 2 is a schematic diagram showing an example of an all-solid-state lithium secondary battery. An all-solid-state lithium secondary battery 1,000 shown in FIG. 2 includes a laminate 100 having a positive electrode 110, a negative electrode 120 and a solid electrolyte layer 130, and an exterior body 200 accommodating the laminate 100. Further, the all-solid-state lithium secondary battery 1,000 may have a bipolar structure in which a CAM and a negative electrode active material are arranged on both sides of a current collector. Specific examples of the bipolar structure include structures described in JP-A-2004-95400.

The positive electrode 110 has a positive electrode active material layer 111 and a positive electrode current collector 112. The positive electrode active material layer 111 contains the above-mentioned CAM and a solid electrolyte. Further, the positive electrode active material layer 111 may contain a conductive material and a binder.

The negative electrode 120 has a negative electrode active material layer 121 and a negative electrode current collector 122. The negative electrode active material layer 121 contains a negative electrode active material. Further, the negative electrode active material layer 121 may contain a solid electrolyte and a conductive material.

The laminate 100 may have an external terminal 113 connected to the positive electrode current collector 112 and an external terminal 123 connected to the negative electrode current collector 122. In addition, the all-solid-state lithium secondary battery 1,000 may have a separator between the positive electrode 110 and the negative electrode 120.

The all-solid-state lithium secondary battery 1,000 further has an insulator (not shown) that insulates the laminate 100 from the exterior body 200, and a sealing body (not shown) that seals an opening 200a of the exterior body 200.

As the exterior body 200, a container obtained by molding a metal material having high corrosion resistance such as aluminum, stainless steel or nickel-plated steel can be used. In addition, as the exterior body 200, a container obtained by processing a laminate film having at least one surface subjected to a corrosion resistant treatment into a bag shape can also be used.

Examples of the shape of the all-solid-state lithium secondary battery 1,000 include shapes such as a coin type, a button type, a paper type (or a sheet type), a cylindrical type, a square type, and a laminate type (pouch type).

Although a form of the all-solid-state lithium secondary battery 1,000 having one laminate 100 is illustrated as an example, the present embodiment is not limited thereto. The all-solid-state lithium secondary battery 1,000 may have a configuration in which the laminate 100 serves as a unit cell and a plurality of unit cells (laminates 100) are sealed inside the exterior body 200.

For the all-solid-state lithium secondary battery, for example, the configuration, materials, and production method described in sections [0151] to [0181] in WO 2022/113904A1 can be used.

Further, another aspect of the present invention includes the following embodiments.

[11] A precursor of CAM, the aforementioned precursor including MCC containing at least one metal element selected from the group consisting of Ni, Co, and Mn, and satisfying all of the following requirements (1)-1 to (3)-1.

(1)-1 The average particle strength is from 20 to 42 MPa.

(2)-1 D₅₀ is more than 4 μm and equal to or less than 20 μm.

(3)-1 The moisture content is from 0.40 to 0.90% by mass and the sulfate radical content is from 0.15 to 0.75% by mass with respect to the total mass of the aforementioned precursor.

[12] The precursor according to [11], wherein the aforementioned MCC is represented by the above composition formula (I).

[13] The precursor according to [11] or [12], wherein the aforementioned MCC is represented by the above composition formula (I)-1.

[14] The precursor according to any one of [11] to [13], which has a standard deviation of particle strength of 3 to 8.95 MPa.

[15] The precursor according to any one of [11] to [14], which has a BET specific surface area of 10 to 46 m²/g.

[16] The precursor according to any one of [11] to [15], which has a tap density of 1.02 to 3.1 g/cm³.

[17] The precursor according to any one of [11] to [16], which has a standard deviation of particle strength of 5 to 8.90 MPa.

[18] The precursor according to any one of [11] to [17], which has a D₅₀ of 6 to 16 μm.

[19] The precursor according to any one of [11] to [18], which has an average particle strength of 25 to 42 MPa.

[20] A method for producing CAM, the method including a mixing step for mixing the precursor according to any one of [11] to [19] with a lithium compound, and a calcination step for calcining the obtained mixture at a temperature of 500 to 1,000° C. in an oxygen-containing atmosphere.

### EXAMPLES

The present invention will be described in more detail below with reference to Examples, but the present invention is not limited thereto.

### <Measurement of Various Parameters of Precursor and MCC>>

Measurements of various parameters of a precursor and MCC produced by the method described below were performed using the measurement methods and the like as described above in the sections entitled (average particle strength), (standard deviation of particle strength), (average particle diameter D₅₀), (moisture content), (sulfate radical content), (composition), (BET specific surface area), (tap density), (XRD pattern), and (method of obtaining α1 and β1).

### <Measurement of Initial Discharge Capacity and Initial Efficiency>

The initial discharge capacity and initial efficiency of a lithium secondary battery were measured by the measurement method as described above in the section entitled (initial discharge capacity and initial efficiency). When the initial discharge capacity is 190 mAh/g or more, the initial discharge capacity is evaluated as high. When the initial efficiency is 84% or more, the initial efficiency is evaluated as high.

### Example 1

After pouring water into a reaction tank equipped with a rotary stirring device having a stirring blade and an overflow pipe, an aqueous sodium hydroxide solution was added thereto, and the liquid temperature (reaction temperature) was maintained at 70° C. An aqueous nickel sulfate solution, an aqueous cobalt sulfate solution, and an aqueous aluminum sulfate solution were mixed so that the molar ratio of Ni:Co:Al was 0.88:0.09:0.03 to prepare a mixed raw material solution 1.

The mixed raw material solution 1 and an aqueous ammonium sulfate solution as a complexing agent were continuously added into a reaction tank while stirring under a nitrogen flow. An aqueous sodium hydroxide solution was added dropwise at appropriate times so that the pH of the mixed solution in the reaction tank became 12.06 (measurement temperature: 40° C.), and the rate of dropwise addition of the aqueous ammonium sulfate solution was adjusted so that the ammonia concentration became 8.2 g/L, thereby obtaining a reaction precipitate 1. It should be noted that the ratio of (volume of solution in reaction tank)/(stirring rotation speed) was 0.625 L/rpm.

The reaction precipitate 1 was washed using an aqueous sodium hydroxide solution (sodium hydroxide concentration: 5% by mass) in a mass 20 times the mass of the reaction precipitate 1. After washing, it was dehydrated in a centrifuge, washed with water, dehydrated, and dried at 105° C. for 20 hours to obtain a precursor 1 as a metal composite hydroxide containing Ni, Co, and Al. Various parameters of precursor 1 are shown in Table 1 (the same applies to Examples 2 and 3 and Comparative Examples 1 to 5 below). It should be noted that 1−x−y−w, x, y, and w in the composition column in Table 1 are values corresponding to those in the composition formula (I)-1 described above.

Lithium hydroxide monohydrate was weighed out so that the amount of Li (molar ratio) with respect to the total amount (taken as 1) of Ni, Co, and Al contained in the precursor 1 was 1.04. The precursor 1 and the lithium hydroxide monohydrate were mixed to obtain a mixture 1.

Then, the obtained mixture 1 was calcined at 720° C. for 6 hours in an oxygen atmosphere to obtain a powder 1. The obtained powder 1 was mixed with pure water adjusted to a liquid temperature of 5° C. so that the mass ratio of the above powder 1 with respect to the total amount was 0.3 to prepare a slurry. The slurry was stirred for 20 minutes, then dehydrated, and further rinsed with pure water adjusted to a liquid temperature of 5° C. in an amount twice the mass of the above powder 1, followed by isolation and drying at 150° C. to obtain a CAM1.

A lithium secondary battery was produced using the obtained CAM1, and the initial discharge capacity and initial efficiency were measured. The results are shown in Table 1 (the same applies to Examples 2 and 3 and Comparative Examples 1 to 5 below).

### Example 2

After pouring water into a reaction tank equipped with a rotary stirring device having a stirring blade and an overflow pipe, an aqueous sodium hydroxide solution was added thereto, and the liquid temperature (reaction temperature) was maintained at 70° C.

An aqueous nickel sulfate solution, an aqueous cobalt sulfate solution, and an aqueous manganese sulfate solution were mixed so that the molar ratio of Ni:Co:Mn was 0.88:0.09:0.03 to prepare a mixed raw material solution 2.

The mixed raw material solution 2 and an aqueous ammonium sulfate solution as a complexing agent were continuously added into a reaction tank while stirring under a nitrogen flow. An aqueous sodium hydroxide solution was added dropwise at appropriate times so that the pH of the mixed solution in the reaction tank became 10.44 (measurement temperature: 40° C.), and the rate of dropwise addition of the aqueous ammonium sulfate solution was adjusted so that the ammonia concentration became 3.3 g/L, thereby obtaining a reaction precipitate 2. It should be noted that the ratio of (volume of solution in reaction tank)/(stirring rotation speed) was 0.625 L/rpm.

The reaction precipitate 2 was washed using an aqueous sodium hydroxide solution (sodium hydroxide concentration: 5% by mass) in a mass 20 times the mass of the reaction precipitate 2. After washing, it was dehydrated in a centrifuge, washed with water, dehydrated, and dried at 105° C. for 20 hours to obtain a precursor 2 as a metal composite hydroxide containing Ni, Co, and Mn.

Lithium hydroxide monohydrate was weighed out so that the amount of Li (molar ratio) with respect to the total amount (taken as 1) of Ni, Co, and Mn contained in the precursor 2 was 1.04. The precursor 2 and the lithium hydroxide monohydrate were mixed to obtain a mixture 2.

Then, the obtained mixture 2 was calcined at 740° C. for 6 hours in an oxygen atmosphere to obtain a powder 2. The obtained powder 2 was mixed with pure water adjusted to a liquid temperature of 5° C. so that the mass ratio of the above powder 2 with respect to the total amount was 0.3 to prepare a slurry. The slurry was stirred for 20 minutes, then dehydrated, and further rinsed with pure water adjusted to a liquid temperature of 5° C. in an amount twice the mass of the above powder 2, followed by isolation and drying at 150° C. to obtain a CAM2.

### Example 3

After pouring water into a reaction tank equipped with a rotary stirring device having a stirring blade and an overflow pipe, an aqueous sodium hydroxide solution was added thereto, and the liquid temperature (reaction temperature) was maintained at 70° C.

An aqueous nickel sulfate solution, an aqueous cobalt sulfate solution, an aqueous manganese sulfate solution, and an aqueous zirconium sulfate solution were mixed so that the molar ratio of Ni:Co:Mn:Zr was 0.60:0.20:0.19:0.01 to prepare a mixed raw material solution 3.

The mixed raw material solution 3 and an aqueous ammonium sulfate solution as a complexing agent were continuously added into a reaction tank while stirring under a nitrogen flow. An aqueous sodium hydroxide solution was added dropwise at appropriate times so that the pH of the mixed solution in the reaction tank became 10.57 (measurement temperature: 40° C.), and the rate of dropwise addition of the aqueous ammonium sulfate solution was adjusted so that the ammonia concentration became 3.3 g/L, thereby obtaining a reaction precipitate 3. It should be noted that the ratio of (volume of solution in reaction tank)/(stirring rotation speed) was 0.375 L/rpm. The reaction precipitate 3 was washed using an aqueous sodium hydroxide solution (sodium hydroxide concentration: 5% by mass) in a mass 20 times the mass of the reaction precipitate 3. After washing, it was dehydrated in a centrifuge, washed with water, dehydrated, and dried at 105° C. for 20 hours to obtain a precursor 3 as a metal composite hydroxide containing Ni, Co, Mn, and Zr.

Lithium hydroxide monohydrate was weighed out so that the amount of Li (molar ratio) with respect to the total amount (taken as 1) of Ni, Co, Mn, and Zr contained in the precursor 3 was 1.08. The precursor 3 and the lithium hydroxide monohydrate were mixed to obtain a mixture 3.

Then, the obtained mixture 3 was calcined at 850° C. for 10 hours in an oxygen atmosphere to obtain a powder 3. The obtained powder 3 was used as a CAM3.

### Comparative Example 1

After pouring water into a reaction tank equipped with a rotary stirring device having a stirring blade and an overflow pipe, an aqueous sodium hydroxide solution was added thereto, and the liquid temperature (reaction temperature) was maintained at 50° C.

An aqueous nickel sulfate solution, an aqueous cobalt sulfate solution, and an aqueous aluminum sulfate solution were mixed so that the molar ratio of Ni:Co:Al was 0.88:0.09:0.03 to prepare a mixed raw material solution 4.

The mixed raw material solution 4 and an aqueous ammonium sulfate solution as a complexing agent were continuously added into a reaction tank while stirring under a nitrogen flow. An aqueous sodium hydroxide solution was added dropwise at appropriate times so that the pH of the mixed solution in the reaction tank became 11.63 (measurement temperature: 40° C.), and the rate of dropwise addition of the aqueous ammonium sulfate solution was adjusted so that the ammonia concentration became 7.6 g/L, thereby obtaining a reaction precipitate 4. It should be noted that the ratio of (volume of solution in reaction tank)/(stirring rotation speed) was 0.625 L/rpm.

The same procedure as in Example 1 was carried out, with the exception that the reaction precipitate 4 was used, to obtain a precursor 4 and CAM 4.

### Comparative Example 2

After pouring water into a reaction tank equipped with a rotary stirring device having a stirring blade and an overflow pipe, an aqueous sodium hydroxide solution was added thereto, and the liquid temperature (reaction temperature) was maintained at 70° C.

An aqueous nickel sulfate solution, an aqueous cobalt sulfate solution, and an aqueous manganese sulfate solution were mixed so that the molar ratio of Ni:Co:Mn was 0.83:0.12:0.05 to prepare a mixed raw material solution 5.

The mixed raw material solution 5 and an aqueous ammonium sulfate solution as a complexing agent were continuously added into a reaction tank while stirring under a nitrogen flow. An aqueous sodium hydroxide solution was added dropwise at appropriate times so that the pH of the mixed solution in the reaction tank became 11.20 (measurement temperature: 40° C.), and the rate of dropwise addition of the aqueous ammonium sulfate solution was adjusted so that the ammonia concentration became 2.0 g/L, thereby obtaining a reaction precipitate 5. It should be noted that the ratio of (volume of solution in reaction tank)/(stirring rotation speed) was 0.375 L/rpm.

The same procedure as in Example 2 was carried out, with the exception that the reaction precipitate 5 was used and the calcination temperature was changed to 780° C., to obtain a precursor 5 and CAM 5.

### Comparative Example 3

After pouring water into a reaction tank equipped with a rotary stirring device having a stirring blade and an overflow pipe, an aqueous sodium hydroxide solution was added thereto, and the liquid temperature (reaction temperature) was maintained at 70° C.

An aqueous nickel sulfate solution, an aqueous cobalt sulfate solution, and an aqueous manganese sulfate solution were mixed so that the molar ratio of Ni:Co:Mn was 0.88:0.09:0.03 to prepare a mixed raw material solution 6.

The mixed raw material solution 6 was continuously added into a reaction tank while stirring under a nitrogen flow. An aqueous sodium hydroxide solution was added dropwise at appropriate times so that the pH of the mixed solution in the reaction tank became 10.41 (measurement temperature: 40° C.), thereby obtaining a reaction precipitate 6. It should be noted that the ratio of (volume of solution in reaction tank)/(stirring rotation speed) was 0.167 L/rpm.

The reaction precipitate 6 was washed using an aqueous sodium hydroxide solution (sodium hydroxide concentration: 5% by mass) in a mass 20 times the mass of the reaction precipitate 6. After washing, it was dehydrated in a centrifuge, washed with water, dehydrated, and dried at 105° C. for 20 hours to obtain a precursor 6 as a metal composite hydroxide containing Ni, Co, and Mn.

Lithium hydroxide monohydrate was weighed out so that the amount of Li (molar ratio) with respect to the total amount (taken as 1) of Ni, Co, and Mn contained in the precursor 6 was 1.04. The precursor 6 and the lithium hydroxide monohydrate were mixed to obtain a mixture 6.

Then, the obtained mixture 6 was calcined at 780° C. for 8 hours in an oxygen atmosphere to obtain a powder 6. The obtained powder 6 was used as a CAM6.

### Comparative Example 4

After pouring water into a reaction tank equipped with a rotary stirring device having a stirring blade and an overflow pipe, an aqueous sodium hydroxide solution was added thereto, and the liquid temperature (reaction temperature) was maintained at 40° C.

An aqueous nickel sulfate solution, an aqueous cobalt sulfate solution, and an aqueous manganese sulfate solution were mixed so that the molar ratio of Ni:Co:Mn was 0.60:0.20:0.20 to prepare a mixed raw material solution 7.

The mixed raw material solution 7 and an aqueous ammonium sulfate solution as a complexing agent were continuously added into a reaction tank while stirring under a nitrogen flow. An aqueous sodium hydroxide solution was added dropwise at appropriate times so that the pH of the mixed solution in the reaction tank became 11.90 (measurement temperature: 40° C.), and the rate of dropwise addition of the aqueous ammonium sulfate solution was adjusted so that the ammonia concentration became 12.0 g/L, thereby obtaining a reaction precipitate 7. It should be noted that the ratio of (volume of solution in reaction tank)/(stirring rotation speed) was 0.007 L/rpm.

The reaction precipitate 7 was dehydrated in a centrifuge, washed with water, dehydrated, and dried at 105° C. for 20 hours to obtain a precursor 7 as a metal composite hydroxide containing Ni, Co, and Mn.

Lithium hydroxide monohydrate was weighed out so that the amount of Li (molar ratio) with respect to the total amount (taken as 1) of Ni, Co, and Mn contained in the precursor 7 was 1.08. The precursor 7 and the lithium hydroxide monohydrate were mixed to obtain a mixture 7.

Then, the obtained mixture 7 was calcined at 850° C. for 10 hours in an oxygen atmosphere to obtain a powder 7. The obtained powder 7 was used as a CAM7.

### Comparative Example 5

After pouring water into a reaction tank equipped with a rotary stirring device having a stirring blade and an overflow pipe, an aqueous sodium hydroxide solution was added thereto, and the liquid temperature (reaction temperature) was maintained at 70° C.

An aqueous nickel sulfate solution, an aqueous cobalt sulfate solution, an aqueous manganese sulfate solution, and an aqueous zirconium sulfate solution were mixed so that the molar ratio of Ni:Co:Mn:Zr was 0.60:0.20:0.19:0.01 to prepare a mixed raw material solution 8.

The mixed raw material solution 8 was continuously added into a reaction tank while stirring under a nitrogen flow. An aqueous sodium hydroxide solution was added dropwise at appropriate times so that the pH of the mixed solution in the reaction tank became 10.53 (measurement temperature: 40° C.), thereby obtaining a reaction precipitate 8. It should be noted that the ratio of (volume of solution in reaction tank)/(stirring rotation speed) was 0.375 L/rpm.

The reaction precipitate 8 was washed using an aqueous sodium hydroxide solution (sodium hydroxide concentration: 5% by mass) in a mass 20 times the mass of the reaction precipitate 8. After washing, it was dehydrated in a centrifuge, washed with water, dehydrated, and dried at 105° C. for 20 hours to obtain a precursor 8 as a metal composite hydroxide containing Ni, Co, Mn, and Zr.

Lithium hydroxide monohydrate was weighed out so that the amount of Li (molar ratio) with respect to the total amount (taken as 1) of Ni, Co, Mn, and Zr contained in the precursor 8 was 1.10. The precursor 8 and the lithium hydroxide monohydrate were mixed to obtain a mixture 8.

Then, the obtained mixture 8 was calcined at 850° C. for 10 hours in an oxygen atmosphere to obtain a powder 8. The obtained powder 8 was used as a CAM8.

TABLE 1

| | Parameters of MCC | | | | | | | | | |
|---|---|---|---|---|---|---|---|---|---|---|
| | | | | | | Average | Particle strength | | | |
| | | | | | | particle | Average | | Impurities | |
| | Composition | | | | | diameter | particle | Standard | Moisture | [symbol] |
| | | | | | Type | D [symbol] | strength | deviation | [% by | [% by |
| | Ni [symbol] | C [symbol] | Mn [symbol] | M [symbol] | of M | [μm] | [MPa] | [MPa] | mass] | mass] |
| Ex. 1 | 0.58 | [symbol] | 0.00 | 0.03 | Al | 12.2 | 41.8 | 8.20 | 0.56 | 0.15 |
| Ex. 2 | 0.88 | 0.09 | [symbol] | — | Absent | 4.3 | 38.8 | 4.42 | 0.86 | 0.60 |
| Ex. 3 | 0.60 | 0.20 | 0.19 | 0.01 | Zr | 6.2 | 24.1 | 8.88 | 0.87 | 0.61 |
| Comp. Ex. 1 | 0.88 | 0.09 | 0.00 | 0.03 | Al | 14.7 | 46.4 | 13.78 | 0.67 | 0.29 |
| Comp. Ex. 2 | 0.83 | 0.12 | 0.05 | — | Absent | 12.6 | 54.8 | 10.71 | 0.67 | 0.14 |
| Comp. Ex. 3 | [symbol] | [symbol] | 0.03 | — | Absent | [symbol] | [symbol] | 15.06 | 0.62 | 0.78 |
| Comp. Ex. 4 | 0.60 | 0.20 | 0.20 | — | Absent | 5.8 | 60.2 | [symbol] | 2.30 | 0.60 |
| Comp. Ex. 5 | 0.60 | 0.20 | [symbol] | 0.01 | Zr | 3.2 | 18.2 | 14.40 | 1.06 | 1.94 |

| | Parameters of MCC | | | | | |
|---|---|---|---|---|---|---|
| | BET | | | | Battery characteristics | |
| | specific | | | | Initial | |
| | surface | Top | | | discharging | Initial |
| | area | [symbol] | α1 + β1 | α1/β1 | capacity | efficiency |
| | [m²/g] | [g/cm³] | [ [symbol] ] | — | [mAh/g] | [%] |
| Ex. 1 | 35.4 | 1.80 | 16.7 | 1.06 | 202 | 88.0 |
| Ex. 2 | 44.8 | 1.04 | 20.8 | 0.87 | 202 | 87.2 |
| Ex. 3 | 23.0 | 1.05 | 22.1 | 1.58 | 199 | 85.0 |
| Comp. Ex. 1 | 40.3 | 1.44 | 24.7 | 0.83 | 187 | [symbol] |
| Comp. Ex. 2 | 8.8 | 2.13 | 31.7 | 0.83 | 188 | 84.4 |
| Comp. Ex. 3 | 42.4 | 1.07 | 18.5 | 0.74 | 189 | [symbol] |
| Comp. Ex. 4 | 9.1 | 1.40 | 28.8 | 0.80 | 192 | 83.1 |
| Comp. Ex. 5 | 21.2 | [symbol] | [symbol] | 1.64 | [symbol] | 86.9 |

[symbol]

indicates data missing or illegible when filed

It was found that the lithium secondary batteries produced using the precursors of Examples 1 to 3 satisfying the requirements (1) to (3) had both high initial discharge capacity and high initial efficiency.

### REFERENCE SIGNS LIST

1: Separator; 2: Positive electrode; 2a: Positive electrode active material layer; 2b: Positive electrode current collector; 3: Negative electrode; 4: Electrode group; 5: Battery can; 6: Electrolytic solution; 7: Top insulator; 8: Sealing body; 10: Lithium secondary battery; 21: Positive electrode lead; 31: Negative electrode lead; 100; Laminate; 110: Positive electrode; 111: Positive electrode active material layer; 112: Positive electrode current collector; 113: External terminal; 120: Negative electrode; 121. Negative electrode active material layer; 122: Negative electrode current collector; 123: External terminal; 130: Solid electrolyte layer; 200: Exterior body; 200a: Opening; 1000. All-solid-state lithium secondary battery

1. A precursor of a positive electrode active material for a lithium secondary battery, said precursor comprising a metal composite compound containing at least one metal element selected from the group consisting of Ni, Co, and Mn, and satisfying all of the following requirements (1) to (3):
(1) An average particle strength is 10 MPa or more and less than 45 MPa;
(2) An average particle diameter D₅₀ is more than 4 μm and equal to or less than 20 μm;
(3) Both a moisture content and a sulfate radical content are 1% by mass or less with respect to the total mass of said precursor.

2. The precursor according to claim 1, wherein said metal composite compound is represented by the following composition formula (I): 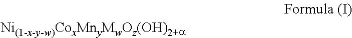
(said composition formula (I) satisfies 0≤x≤0.5, 0≤y≤0.5, 0≤w≤0.5, 0≤x+y+w<1.0≤z≤3, −0.5≤α≤2, and α−z<2, and M is one or more elements selected from the group consisting of Fe, Cu, Ti, Mg, Al, Zn, Sn, Zr, Nb, Ga, W, Mo, B, and Si.)

3. The precursor according to claim 1, which has a standard deviation of particle strength of 1 MPa or more and 9 MPa or less.

4. The precursor according to claim 1, which has a BET specific surface area of 2 m²/g or more and 50 m²/g or less.

5. The precursor according to claim 1, which has a tap density of 1.0 g/cm³ or more and 3.5 g/cm³ or less.

6. A method for producing a positive electrode active material for a lithium secondary battery,
the method comprising
a mixing step for mixing the precursor of claim 1 with a lithium compound, and
a calcination step for calcining the obtained mixture at a temperature of 500° C. or more and 1,000° C. or less in an oxygen-containing atmosphere.
